(19) United States
(12) Patent Application Publication
(10) Pub. No.: US 2020/0123033 A1
(43) Pub. Date: Apr. 23, 2020

(54) Composition and method for reducing halogenated decomposition byproducts in the water of aquatic facilities

(71) Applicant: Roy W. Martin, Downers Grove, IL (US)

(72) Inventor: Roy W. Martin, Downers Grove, IL (US)

(73) Assignee: Truox, Inc., McClellan, CA (US)

(21) Appl. No.: 16/602,392

(22) Filed: Sep. 26, 2019

Related U.S. Application Data
(60) Provisional application No. 62/766,462, filed on Oct. 19, 2018.

(51) Int. Cl. C02F 1/72; C02F 1/76

(52) U.S. Cl. CPC C02F 1/725; C02F 2103/42; C02F 1/76; C02F 1/722

(57) ABSTRACT

A method and composition for reducing halogenated decomposition byproducts in the water and air of an aquatic facility. The invention comprises a water soluble metal-porphyrin catalyst that accelerates oxidation of the halogenated decomposition byproducts and their precursors. The catalyst remains stable and only requires replenishment relative to the makeup water added to the treated aquatic facility. The average time interval of replenishment can be measured in weeks or months.

### FIELD OF INVENTION

This invention relates to an improved catalyst for the generation of sulfate free radicals in the water of an aquatic facility for the removal and inhibition of halogenated decomposition byproducts.

### BACKGROUND

Indoor pools are notorious for producing chlorinated decomposition byproducts that result in odors, irritation of the eyes, sinuses, respiratory system, as well as corrosion of air handling equipment often leading to using excess outside air exchange to dilute the air within the facility. This can increase energy cost by hundreds of U.S. dollars per day. Outdoor pools can also experience the problems related to accumulation of chlorinated decomposition byproducts, however air quality is not as much an issue due to rapid dilution.

U.S. Pat. No. 7,476,333 describes a dry composition for reducing chemical oxygen demand in water. The composition comprises potassium monopersulfate and a transition metal catalyst.

U.S. Pat. No. 7,572,384 describes a method for removing chemical oxygen demand from water in an aquatic facility, the method comprising adding a composition comprising a persulfate donor and a transition metal catalyst. The composition is applied to sustain at least 1 ppb transition metal catalyst reported as elemental metal.

U.S. Pat. No. 7,695,631 describes a method of removing organic contaminants in the water of an aquatic facility using in-situ generated sulfate free radicals, the method comprising adding a transition metal catalyst to sustain at least 5 ppb as elemental metal and sustaining less than 2 ppm of persulfate.

The referenced prior art has proven to be very effective at improving water and air quality at aquatic facilities treated with these compositions and methods. However, the use of traditional chelants to stabilize the transition metal catalyst is quickly oxidized resulting in precipitation of the metal oxide and depletion of its catalytic effect. In some instances precipitation has resulted in staining of the floor of the swimming pool

The oxidation of the chelant is the result of the exposed nitrogen atoms exposure to the chlorine used for sanitation. As a result the chelated catalyst requires routine replenishment and in the case of compositions that comprise the catalyst, higher catalyst dosages are required to benefit from the formation of sulfate free radicals. If the catalyst is depleted prior to converting the persulfate donor to sulfate free radicals, the desired effect is not achieved.

Another disadvantage of the compositions of the prior art is that the dry composition must remain dry and either added directly to the water of the aquatic facility of be quickly dissolved and applied immediately using a dry feeder. The compositions cannot be dissolved in water and applied over an extended period of time (e.g. days or weeks) as the catalyst rapidly decomposes the persulfate donor. As a result, the prior art treatment cannot be applied continuously while bathers are present without adding more catalyst to replenish the precipitated (oxidized) catalyst.

There is a need for a water soluble catalyst that can resist oxidation from the free halogen oxidizers (i.e. chlorine) used to disinfect the water of aquatic facilities thereby preventing precipitation of the transition metal catalyst.

### SUMMARY

There are several significant benefits over the prior art that are achieved as a result of utilizing metal-porphyrin catalyst over EDTA and other traditional chelant technologies that are readily susceptible to oxidation in the presence of free halogen oxidizers (i.e. chlorine).

The prior art Patents disclosed compositions and methods requiring the catalyst be applied along with the persulfate precursor in the form of a composition, or be applied separately but along with the persulfate donor to sustain preferably 5 ppb or more catalyst reported as elemental metal. While the traditional chelants (i.e. EDTA) improve the water solubility and extend the activity of the catalyst, they are readily susceptible to oxidation and precipitate, requiring more catalyst as it is continually depleted in order to sustain an effective amount in the pool water.

It has been demonstrated the disclosed water soluble metal-porphyrin catalyst results in a dramatic reduction in the amount of transition metal catalyst required to maintain an effective amount in the water of an aquatic facility while achieving dramatic reductions in halogenated decomposition byproducts (DBPs) and precursors of said DBPs (i.e. urea).

The inherent resistance to oxidation and improved stability eliminates the need for routine replenishment of the catalyst. Furthermore the potential for precipitation and staining is effectively eliminated.

Using metal-porphyrin catalyst only requires supplemental addition of the catalyst that is relative to the make-up water added to the swimming pool (i.e. water losses). Water is lost due to backwashing of the filters, splashing and/or lowering dissolved solids (dilution). Because the metal-porphyrin catalyst only requires replenishing relative to these water losses, supplemental addition of the metal-porphyrin composition can occur over a period of weeks or months based on the rate of the water loss.

The water soluble metal-porphyrin should be applied to obtain between 0.01 to 50 ppb, more preferred 0.1 to 30 ppb and most preferred 0.2 to 20 ppb reported as water soluble metal-porphyrin.

Due to the high stability of the metal-porphyrin catalyst in the presence of free halogen, only low concentrations of metal catalyst (as elemental metal) are required to achieve an effective amount to support ongoing generation of sulfate free radicals. For example, the molecular weight of 4,4′,4″,4′″-(Porphine-5,10,15,20-tetrayl) tetrakis (sulfonic acid) Cobalt is approximately 1422 g/mol, wherein cobalt comprises less than 4.2 wt %. At the maximum concentration of 50 ppb as metal-porphyrin the cobalt contribution as elemental cobalt comprises approximately 2 ppb as Co. This concentration comprises 40% of the preferred minimum elemental cobalt claimed in the prior art. Furthermore, because the metal-porphyrin catalyst does not require continuous replenishment like the prior art metal-chelant catalyst due to its inherent oxidative resistance, the generation of sulfate free radicals can be accomplished 24/7 for weeks or even months without concern of staining or the need and cost of replenishing the catalyst.

Due to the fact that such low concentrations of metal-porphyrin catalyst are required to maintain and effective amount, it may be desirable to combine the catalyst with a tracer for ease of measuring the relative amount of catalyst since sophisticated laboratory instrumentation is required to measure ≤ppb levels of metal catalyst are not available at aquatic facilities or the trained personnel to use them. One non-limiting example of an effective tracer is sodium molybdate (Na₂MoO₄). Molybdate is at a high oxidation state so it is inert to the chlorine and oxidizers being used to treat the swimming pool water. Other non-limiting examples include potassium molybdate, lithium molybdate and the like. Any suitable molybdate donor can be used.

The concentration of molybdate in the water of the aquatic facility can range from 0.05 to 2 ppm, more preferred the concentration ranges from 0.08 to 0.8 ppm, and most preferred 0.10 to 0.60 ppm reported as MoO₄⁼.

The compositions of the invention comprising the water soluble metal-porphyrin catalyst can in the form of a liquid or solid. The compositions of the invention can be mixed with other salts or swimming pool treatments exemplified by the non-limiting examples: sodium bicarbonate, potassium monopersulfate, sodium bromide, sodium carbonate and sodium chloride to name a few.

When combined with a molybdate tracer, the molybdate can be easily measured to determine the relative concentration of catalyst in the water. As water is lost from the swimming pool due to filter backwashing, leaks, splashing etc. the concentration of molybdate will decrease. Additional composition comprising the metal-porphyrin catalyst and molybdate tracer can be added to the swimming pool water to sustain the effective amount of catalyst.

Another significant benefit offered by using the disclosed metal-porphyrin catalyst is the ability to apply the metal-porphyrin catalyst and persulfate donor to the water of an aquatic facility separately. Metal-porphyrin catalyst comprising metal ions exemplified by the non-limiting examples Co, Ru and/or Fe accelerate the decomposition of potassium monopersulfate. Compositions comprising potassium monopersulfate and said catalyst cannot be formed into a solution and applied to the water of the aquatic facility over an extended period of time (e.g. days or weeks) due to the rapid decomposition of the persulfate donor. By applying the metal-porphyrin catalyst having superior oxidative resistance and longevity to the water of the aquatic facility, solutions of persulfate donor (i.e. potassium monopersulfate) can be fed continually or intermittently for an extended period of time (e.g. days and weeks) from a single liquid batch of persulfate donor.

### DESCRIPTION OF FIGURES

FIG. 1 illustrates the reduction in decomposition byproducts and their precursor Urea after addition of the metal-porphyrin catalyst.

FIG. 2 illustrates the longevity and stability of the metal-porphyrin catalyst in chlorinated water of an aquatic facility. The effectiveness resulting from the in-situ generation of sulfate free radicals was sustained in excess of 4 weeks. After loss of catalyst (e.g. filter backwashing, splashing etc) the urea slowly began to increase but remained well below those levels before the addition of the catalyst indicating slower but still effective decomposition resulting from sulfate free radical oxidation.

FIG. 3 illustrates the general structure of metal-porphyrin catalyst.

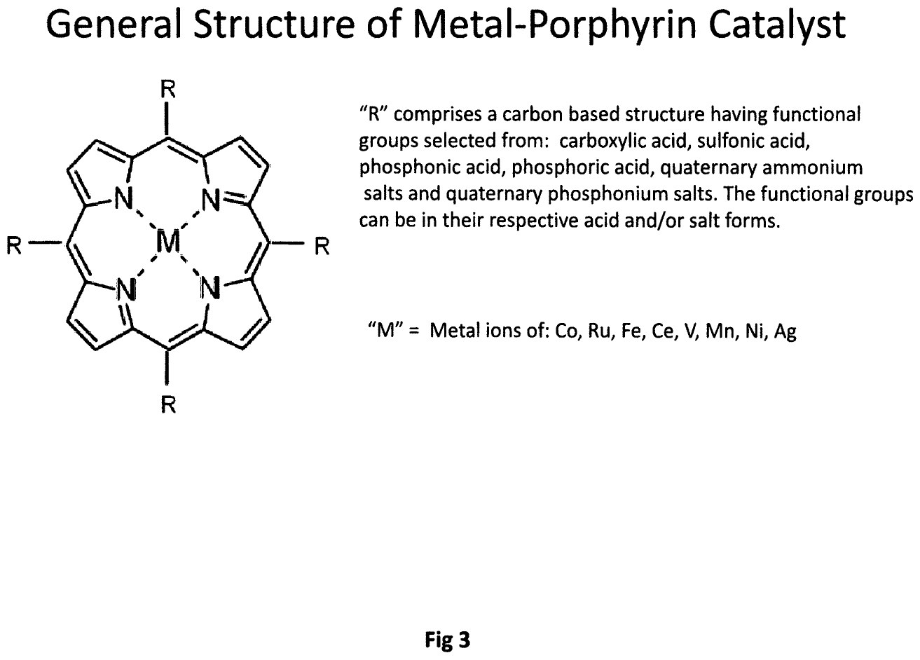

FIG. 4 illustrates one preferred water soluble metal porphyrin.

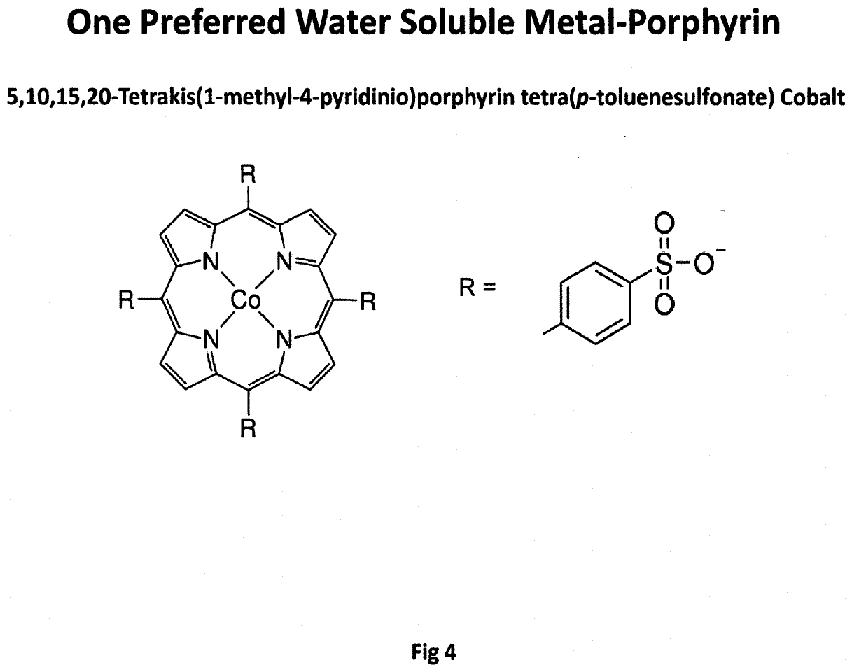

### DETAILED DESCRIPTION OF THE EMBODIMENT(S)

The following terms will be used throughout the specification and will have the following meanings unless otherwise indicated.

“A” or “an” means “at least one” or “one or more” unless otherwise indicated.

“Comprise”, “have”, “include” and “contain” (and their variants) are open-ended linking verbs and allow the addition of other elements when used in a claim. “Consisting of” is closed, and excludes all additional elements.

“Consisting essentially of” excludes additional material elements, but allows the inclusions of non-material elements that do not substantially change the nature of the invention.

“Effective amount” refers to an amount of metal-porphyrin catalyst sufficient to impart a measurable reduction in the concentration of halogenated decomposition byproducts (DBPs) and/or organic contaminants (all comprising “oxidant demand”) that form decomposition byproducts (precursors) compared to results achieved by applying persulfate donor without an effective amount of said catalyst.

As used herein, a “persulfate donor” is a compound that when catalyzed by the water soluble metal-porphyrin produces sulfate free radicals. Non-limiting examples of persulfate donors include: sodium persulfate, potassium persulfate and potassium monopersulfate.

As used herein, the term “free halogen” is used with reference to a halogen source which acts as an active sanitizer when dissolved in water. Chlorine based free halogen forms at least one of (Cl₂, HOCl, OCl⁻) when added to water, whereby the species formed is pH dependent. Bromine based free halogen form at least one of (Br₂, HOBr, OBr⁻), again the species being pH dependent.

As used herein, the term “filtration” is used with reference to a process of physically removing or trapping water insoluble particles. Filtration typically requires passing water through a filter media such as sand or a membrane to trap the particles while allowing the water to pass thru the filter media.

As used herein, the term “peroxymonosulfate” encompasses the various species of the peracid chemistry and its various salts, whereby depending on the pH of the solution in which the peroxymonosulfate is added, the following species and combinations result: H₂SO₅ (Caro's acid), HSO₅⁻, SO₅⁼.

As used herein, the term “alkali metal salts of monopersulfate” includes but is not limited to potassium monopersulfate, and/or sodium monopersulfate. Potassium monopersulfate is commercially available under the trade names Caroat® (United Initiators) and Oxone® (E.I. DuPont). Synonyms include peroxymonosulfate.

“Monopersulfate donor” can be any convenient source of monopersulfate. Monopersulfate dissolved in water forms HSO₅⁻, and/or SO₅⁼ ions depending on solution pH.

As used herein, “relative to the amount of makeup water” is the amount (i.e. volume) of water added to the Aquatic Facility Circulating System as a result of filter backwashing, splashing, leaks and lowering dissolved solids (i.e. dilution). Evaporation of water results in the need to add make up water, however it does not lower the concentration of catalyst. So the addition of catalyst to sustain an effective amount of catalyst is relative to the makeup water requirements to maintain proper pool water level.

As used herein, the term “aquatic facility” is used with reference to all structural components and equipment exposed to the environment associated with an aqueous system. Examples of aquatic facilities include, but are not limited to: water parks, theme parks, swimming pools, spas, features such as fountains, waterfalls and the like. An indoor aquatic facility may include air handling systems and dehumidification systems that are exposed to the environment resulting from the aqueous system (i.e. swimming pool).

As used herein, “water” describes the water portion of the aquatic facility.

As used herein, the term “skimmer” and “gutter” systems are used with reference to a portion of an aquatic facilities water circulating system. Skimmers and gutter systems collect and transport surface water from the main body of water comprising the swimming pool, spa, water-park ride etc. The water is pumped, filtered, and sometimes treated before being returned to the main pool or spa water. Treated added to the skimmer or gutters will contact the filter media as the water is circulated through the system.

As used herein, the term “Aquatic Facility Circulating System” is part of the aqueous system of the aquatic facility comprising at least: a body of water such as a swimming pool, a means for collecting water such as a gutter, skimmer and/or main drain, pipes to transport the said collected water to a pump, a filter to remove water insoluble matter, and a piping system that returns the circulated water back to the body of water (pool).

As used herein, “functional group” and “functional groups” shall describe the acid and salt forms of the functional group interchangeably. For example describing a functional group as carboxylic acid shall include the carboxylate salts. The description of a functional group may also use the general group name exemplified by carboxyl and sulfo to describe carboxylic acid (& salts) and sulfonic acid (and salts) respectively.

As used herein, “oxidant demand” describes the accumulation of halogenated decomposition byproduct and their precursors exemplified by urea and enzymes that reduce the Oxidation Reduction Potential (ORP) for a given amount of free halogen in the water. As oxidant demand from these contaminates increases, the ORP decreases resulting in the feed of free halogen in order to sustain the ORP set point on the ORP controller. This increases the free halogen concentration, accelerating the formation of more decomposition byproducts.

The invention is based on utilizing a water-soluble metal-porphyrin catalyst to activate persulfate donors in the water of an aquatic facility to produce sulfate free radicals for the remediation of halogenated decomposition byproducts as well as reduce the potential for their formation by accelerating the oxidation of organic based contaminants also referred to as precursors (i.e. Urea).

As a result of reducing the concentration of halogenated decomposition byproducts (DBPs) in the water, the partial pressure of the DBPs is reduced and air quality is dramatically improved. Respiratory discomfort as well as equipment corrosion is effectively mitigated.

The water soluble metal porphyrin catalyst is comprised of a parent porphine that is substituted with functional groups that impart water solubility. The parent porphine has the general structure:

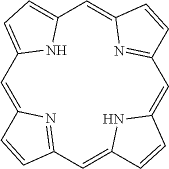 [SMILES: C1=Cc2cc3ccc(cc4nc(cc5ccc(cc1n2)[nH]5)C=C4)[nH]3]

One non-limiting example of a substituted porphine to produce a water soluble metal-porphyrin catalyst having the generational structure:

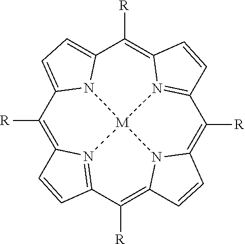

Where “R” comprises carbon based structures terminated with one or more functional groups, and
“M” is a metal ion selected from at least one of: Co, Ru, Fe, Ce, V, Mn, Ni, Ag.

The substituted “R” groups can be alkyl, aryl, alkyl aryl and can be attached to any suitable location on the parent porphine to increase water solubility.

Functional groups can be selected from carboxylic acid (carboxyl), sulfonic acid (sulfo), phosphonic acid (phosphono), phosphoric acid (phosphate), quaternary ammonium salts and quaternary phosphonium salts. The functional groups can be in their respective acid and/or salt forms. For example a carboxyl functional group may be in its carboxylic acid form or partially or completely neutralized. Examples of suitable counter ions include sodium, potassium, lithium, ammonium and amine.

The number of functional groups terminating an “R” group is one or more.

It is desirable that the functional groups be resistant to oxidation from chlorine. Preferred functional groups include: sulfonic acid, carboxylic acid, phosphonic acid and phosphoric acid. Quaternary based functional groups can be used but are more susceptible to oxidation.

The transition metal ion can be selected from the group consisting of: Mn(II), Mn(III), Fe(II), Fe(III), Co(II), Co(III), Ni(II), Ni(III), V(III), V(IV), Ce(III), Ce(IV), Ru(III), Ru(IV), Ag(I).

It is believed the stability of the metal-porphyrin catalyst is attributed to steric hindrance. The combination of the bulky metal ion internally bonded with the heterocyclic nitrogen effectively shields the nitrogen from oxidation.

The persulfate donor can be applied continuously, intermittently or as a shock treatment depending on the amount of oxidant demand and/or water and air quality. One preferred method is to make an aqueous solution of the persulfate donor and apply it to the water of the aquatic facility continuously. This method provides a means for reacting the organic based demand (precursors) introduced by the patrons (swimmers) with sulfate free radicals before they produce DBPs. Complex organics such as globular proteins found in saliva can be rapidly decomposed thereby preventing days or weeks of reactions with chlorine that results in accumulation of DBPs.

Shock feeding persulfate donor can also be applied by broadcasting powder or liquid version of the persulfate donor into the pool water. This is useful after heavy bather loading such as a swimming competition etc. The formation of sulfate free radicals decomposes the complex organics making them more reactive to weaker oxidizers such as potassium monopersulfate.

The composition comprising the water soluble metal porphyrin catalyst can be applied to sustain an effective amount of catalyst in the water. The composition can be applied intermittently to replenish loses while sustaining an effective amount of catalyst even while the makeup water requirements fluctuate. The composition can be applied by continuous feed, intermittent feed or as a slug feed such as in the case of applying n initial dose of catalyst during startup of the treatment program. The potential for slow dissolving tablets or membrane controlled release may be suitable as well.

The first embodiment of the invention is a method for reducing the halogenated decomposition byproducts in the water and air of an aquatic facility, the method comprising: adding a composition to the water to achieve an effective amount of water soluble metal-porphyrin catalyst; applying a persulfate donor to the water; reacting the persulfate donor with the metal-porphyrin catalyst to produce sulfate free radicals; reacting the sulfate free radicals with halogenated decomposition byproducts and their precursors thereby reducing their concentration, and wherein an effective amount of metal-porphyrin catalyst is sustained by applying said composition relative to the amount of makeup water added to the aquatic facility.

In the second embodiment, the invention is a composition comprising a water soluble metal-porphyrin catalyst and a tracer comprising a molybdate donor for detecting the relative concentration of catalyst in the water. The composition can be applied to the water of indoor and outdoor aquatic facilities to promote the in-situ generation of sulfate free radicals from persulfate donors.

In the third embodiment, the invention comprising applying the composition of the second embodiment to the water of an aquatic facility, measuring the concentration of tracer, and adding the composition to the water of the aquatic facility to maintain an effective amount of said metal-porphyrin catalyst by sustaining the desirable range of tracer.

In the fourth embodiment, the invention comprises a method for reducing the oxidant demand in the water of an aquatic facility, the method comprising: adding a composition to the water to achieve an effective amount of water soluble metal-porphyrin catalyst; applying a persulfate donor to the water; reacting the persulfate donor with the metal-porphyrin catalyst to produce sulfate free radicals; reacting the sulfate free radicals with the oxidant demand thereby reducing their concentration, and wherein an effective amount of metal-porphyrin catalyst is sustained by applying said composition relative to the amount of makeup water added to the aquatic facility.

In accordance with the first and fourth embodiment, the effective amount of metal-porphyrin catalyst is sustained by applying the composition relative to the amount of makeup water which occurs over average time intervals measured in weeks or months.

### Water Soluble Metal Porphyrin Catalyst

The preferred metal-porphyrin catalysts comprise transition metals selected from cobalt, ruthenium and iron. Some preferred non-limiting examples of a preferred metal-porphyrin catalyst comprise: 4,4′,4″,4′″-(Porphine-5,10,15,20-tetrayl) tetrakis (benzoic acid) Cobalt; 4,4′,4″,4″-(Porphine-5,10,15,20-tetrayl) tetrakis (benzoic acid) Ruthenium; 4,4′,4″,4′″-(Porphine-5,10,15,20-tetrayl) tetrakis (sulfonic acid) Cobalt, and 4,4′,4″,4′″-(Porphine-5,10,15,20-tetrayl) tetrakis (sulfonic acid) Ruthenium.

### Field Study

A 121,000 gallon indoor swimming pool experienced heavy bather loading due to lap swimming from 6-8 am and 5-8 pm with various classes and open swimming between.

The pool water was treated with calcium hypochlorite and muriatic acid controlled using an ORP/pH controller.

The air and water chemistry was tested for various chlorinated decomposition byproducts exemplified by chloroform, cyanogens chloride and trichloramine using a Membrane Mass Spectrometer (MIMS) as well as precursors of DBPs exemplified by Urea.

A storage tank was equipped with a mixer and peristaltic pump. The outlet of the pump was connected post heater to inject potassium monopersulfate solution into the circulating water being returned to the swimming pool. The tank was filled with approximately 30 gallons of water into which 50 lbs of potassium monopersulfate was added and mixed until dissolved.

The feed of potassium monopersulfate solution was started and applied 24/7 for several weeks prior to the addition of the metal-porphyrin catalyst to demonstrate the before and after results achieved with the addition of an effective amount of metal-porphyrin catalyst. The target feed rate was between 3-4 gpd.

After several weeks of treating the water of the aquatic facility with a solution of potassium monopersulfate, a solid composition containing 1000 mg of water soluble metal porphyrin comprising 5,10,15,20-Tetrakis(1-methyl-4-pyridinio) porphyrin tetra(p-toluenesulfonate) Cobalt was added to the water of the aquatic facility.

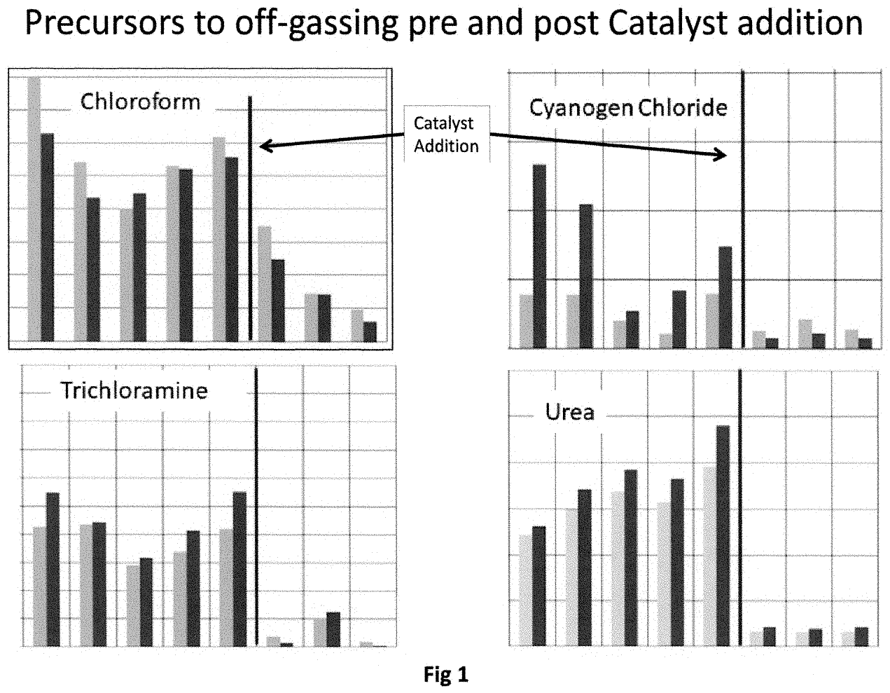

FIG. 1 illustrates the effects on DBPs and urea before and after addition of the metal-porphyrin catalyst.

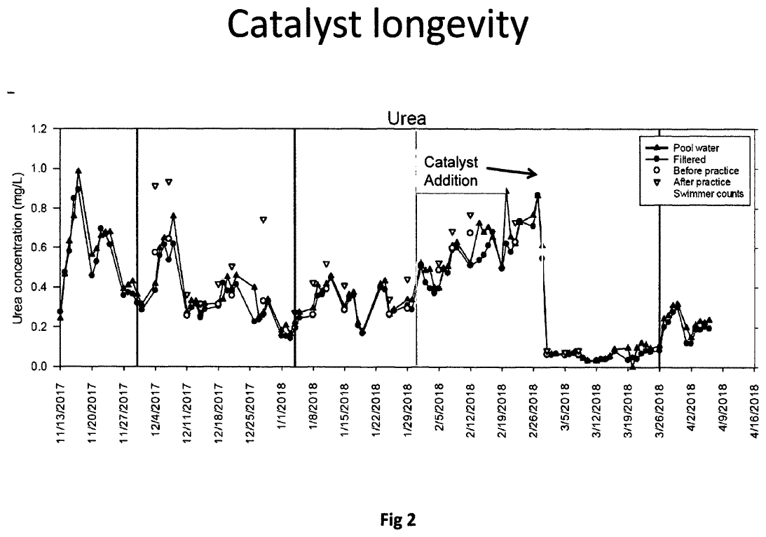

FIG. 2 illustrates that a single low dose comprising approximately 2.1 ppb as metal-porphyrin (88 ppt as Co) was able to sustain the high rate of oxidation due to the formation of sulfate free radicals for well over 4 weeks after its addition.

The superior oxidation and rapid decomposition of DBPs, as well as the precursors that lead up to the formation of DBPs, is clearly evident and results in superior water and air quality.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention.

What is claimed is:

1. A method for reducing the halogenated decomposition byproducts in the water and air of an aquatic facility, the method comprising:
adding a composition to the water to achieve an effective amount of water soluble metal-porphyrin catalyst; applying a persulfate donor to the water; reacting the persulfate donor with the metal-porphyrin catalyst to produce sulfate free radicals; reacting the sulfate free radicals with halogenated decomposition byproducts and their precursors thereby reducing their concentration, and
wherein an effective amount of metal-porphyrin catalyst is sustained by applying the composition relative to the amount of makeup water added to the aquatic facility.

2. The composition in accordance with claim 1, wherein the metal-porphyrin catalyst having the generational structure: 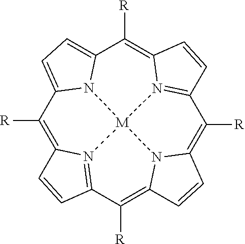
Where “R” comprises carbon based structures terminated with one or more functional groups, and
“M” is a metal ion selected from at least one of Co, Ru, Fe, Ce, V, Mn, Ni, Ag.

3. The composition in accordance with claim 2, wherein the metal ion comprises cobalt.

4. The composition in accordance with claim 2, wherein the metal ion comprises ruthenium.

5. The composition in accordance with claim 2, wherein the metal ion comprises iron.

6. The composition in accordance with claim 2, wherein “R” is terminated with a carboxylate functional group.

7. The composition in accordance with claim 2, wherein “R” is terminated with a sulfonate functional group.

8. The composition in accordance with claim 2, wherein “R” is terminated with a phosphonate functional group.

9. The composition in accordance with claim 2, wherein “R” is terminated with a phosphate functional group.

10. The composition in accordance with claim 2, wherein R is terminated with a phosphonium quaternary functional group.

11. The composition in accordance with claim 2, wherein R is terminated with an ammonium quaternary functional group.

12. The composition in accordance with claim 1, wherein the metal-porphyrin catalyst comprises 4,4′,4″,4″-(Porphine-5,10,15,20-tetrayl) tetrakis (benzoic acid) Cobalt.

13. The composition in accordance with claim 1, wherein the metal-porphyrin catalyst comprises 4,4′,4″,4″-(Porphine-5,10,15,20-tetrayl) tetrakis (sulfonic acid) Cobalt.

14. The method in accordance with claim 1, wherein the persulfate donor comprises potassium monopersulfate.

15. The method in accordance with claim 1, wherein the persulfate donor comprises potassium persulfate.

16. The method in accordance with claim 1, wherein the persulfate donor comprises sodium persulfate.

17. The method in accordance with claim 1, wherein the effective amount of metal-porphyrin catalyst is between 0.01 to 50 ppb reported as metal-porphyrin.

18. The method in accordance with claim 17, wherein the effective amount of metal-porphyrin catalyst is between 0.1 to 30 ppb reported as metal-porphyrin.

19. The method in accordance with claim 18, wherein the effective amount of metal-porphyrin catalyst is between 0.2 to 20 ppb reported as metal-porphyrin.

20. The method in accordance with claim 1, wherein the composition further comprises a molybdate donor.

21. The composition in accordance with claim 20, wherein the molybdate donor comprises sodium molybdate.

22. The method in accordance with claim 20, wherein the molybdate concentration is sustained between 0.05 to 2 ppm reported as MoO₄⁼.

23. The method in accordance with claim 22, wherein the molybdate concentration is sustained between 0.08 to 0.8 ppm reported as MoO₄⁼.

24. The method in accordance with claim 23, wherein the molybdate concentration is sustained between 0.1 to 0.6 ppm reported as MoO₄⁼.

25. The method in accordance with claim 1, wherein the effective amount of metal-porphyrin catalyst is sustained by applying the composition relative to the amount of makeup water which occurs over average time intervals measured in weeks or months.
